(19) United States
(12) Patent Application Publication
(10) Pub. No.: US 2022/0365597 A1
(43) Pub. Date: Nov. 17, 2022

(54) USER INTERFACE WITH DYNAMIC TOUCH ATTRACTION

(71) Applicant: Toyota Research Institute, Inc., Los Altos, CA (US)

(72) Inventors: Hiroshi Yasuda, San Francisco, CA (US); Manuel Ludwig Kuehner, Mountain View, CA (US); Scott Michael Harris, San Jose, CA (US)

(21) Appl. No.: 17/322,261

(22) Filed: May 17, 2021

(51) Int. Cl. G06F 3/01; G06F 3/0488; G06F 3/0354; H01F 7/06

(52) U.S. Cl. CPC G06F 3/014; G06F 3/04886; G06F 3/0354; H01F 7/064; G06F 2203/0331; G06F 2203/04108; G06F 3/044

(57) ABSTRACT

System, methods, and other embodiments described herein relate to a touch-based interface that dynamically generates attractive forces to facilitate a user locating interactive features on the interface. In one embodiment, a method includes identifying an interactive location within an interface according to a current state of the interface. The method includes correlating the interactive location with attracting elements within a device displaying the interface. The method includes activating at least one corresponding element of the attracting elements to attract an interface element associated with a user to the interactive location.

### TECHNICAL FIELD

The subject matter described herein relates, in general, to systems and methods for improving a touch-based user interface, and, more particularly, to dynamically generating attractive forces to facilitate a user locating interactive features of the interface.

### BACKGROUND

Touch interfaces are a common mechanism for users to interact with many different electronic devices. For example, touch interfaces can include touch screens, touchpads, touch sliders, touch buttons, and so on. However, using touch interfaces in an unstable environment, such as within a moving vehicle, can be difficult because of movement between the user and the interface. In the context of a vehicle where the touch interface may be on a center console, the more the arm of the user is outstretched, the more difficult precise finger pointing becomes when, for example, attempting fine motor placement of a finger on the touch interface. Some users may also experience difficulties with an outstretch arm due to physical disabilities or other ailments that can cause tremors, thereby complicating fine movements. Moreover, in a car, negative influences, such as vibrations or inertial forces due to accelerations, can further complicate the accurate placement of a finger on an interface. This issue of accurate placement on an interface can be even further exacerbated when a particular interface includes small targets with a high density. Accordingly, accurately using a touch interface within a moving vehicle can be difficult, which may lead to difficulties adjusting controls and/or a reduced user experience overall.

### SUMMARY

Embodiments include systems and methods that relate to improving a touch-based interface by dynamically generating attractive forces associated with interactive regions of the interface. As previously noted, using a touch-based interface can encounter various difficulties when, for example, using such an interface within a moving vehicle or another unstable platform. For example, in one arrangement, an interface system controls a display device to activate selected attracting elements that correspond with interface locations within a user interface that is being displayed. Consider that the display device can include an electronic display that is touch-based and thus accepts user inputs through the touch of the display. Further, consider that the display device may include a grid of attracting elements behind a display screen that can be individually activated. Thus, the display device functions to display an interface to a user for controlling various aspects of, for example, a vehicle, such as climate control, infotainment, and so on.

Additionally, a user may use an interface element to improve interaction with the display device. The interface element may be an implement that fits over a finger of the user and is infused with magnetically responsive material, such as iron. The interface element itself may also maintain capacitive characteristics similar to human skin such that contact with the touch-based display device functions similar to touch by the user without the interface element. Accordingly, the interface system can acquire a current state of an interface that is displayed on the display device and identify different interactive locations within the interface. The interactive locations may include buttons, sliders, and other features. Upon identifying the interactive locations, the system then, in one arrangement, correlates the interactive locations with the attracting elements. Correlating the interactive locations may include simply identifying which of the attracting elements correspond. In a further arrangement, the correlating may further include determining whether multiple attracting elements correspond to a single interactive location, whether an attracting element that corresponds exceeds boundaries of the interactive location, and so on. In these various circumstances, the system may correlate multiple attracting elements with a single interactive location, throttle (i.e., decrease) a force emitted by a corresponding element, and so on in order to maintain correspondence within an area of the interaction location.

In any case, once correlated, the interface system activates the corresponding attracting elements to attract the interface element to the interactive location. The interface system may further monitor for changes to the interface and update which of the attracting elements are active accordingly. Moreover, in order to improve interaction with the display device, the interface system also, in one arrangement, monitors a proximity of the interface element to the surface of the display. Thus, the interface system may adapt the attracting force according to the proximity such that as the interface element is about to contact the surface, the attracting force can be reduced or wholly eliminated. In this way, the guidance provided by the interface system is subtle and helps guide the interface element without causing undesired attraction that may be difficult to relieve. In any case, the interface system improves interaction with a touch-based interface by improving the ability of a user to accurately provide inputs in environment that are unstable.

In one embodiment, an interface system is disclosed. The interface system includes one or more processors and a memory communicably coupled to the one or more processors. The memory stores an activation module including instructions that, when executed by the one or more processors, cause the one or more processors to identify an interactive location within an interface according to a current state of the interface. The activation module includes instructions to correlate the interactive location with attracting elements within a device displaying the interface. The activation module includes instructions to activate at least one corresponding element of the attracting elements to attract an interface element associated with a user to the interactive location

In one embodiment, a non-transitory computer-readable medium including instructions that, when executed by one or more processors, cause the one or more processors to perform various functions is disclosed. The instructions include instructions to identify an interactive location within an interface according to a current state of the interface. The instructions include instructions to correlate the interactive location with attracting elements within a device displaying the interface. The instructions include instructions to activate at least one corresponding element of the attracting elements to attract an interface element associated with a user to the interactive location.

In one embodiment, a method is disclosed. In one embodiment, the method includes identifying an interactive location within an interface according to a current state of the interface. The method includes correlating the interactive location with attracting elements within a device displaying the interface. The method includes activating at least one corresponding element of the attracting elements to attract an interface element associated with a user to the interactive location.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented.

FIG. 2 illustrates one embodiment of an interface system that is associated with using attracting elements to facilitate the use of a touch-based interface.

FIG. 3 is a diagram illustrating one example of a grid of attracting elements.

FIG. 4 is an illustration of an interface element worn by a user.

FIG. 5 illustrates one arrangement of interactive locations within a display device.

FIG. 6 illustrates a diagram of active attracting elements relative to interactive locations with varying levels of attracting forces.

FIG. 7 illustrates one example of an interface element proximate to a display device.

FIG. 8 illustrates one embodiment of a flowchart associated with a method of facilitating interaction with a touch-based interface.

### DETAILED DESCRIPTION

Systems, methods, and other embodiments associated with improving a touch-based interface by dynamically generating attractive forces associated with interactive regions of the interface are disclosed. As previously noted, using a touch-based interface can encounter various difficulties when, for example, using such an interface within a moving vehicle or another unstable platform. For example, in one arrangement, an interface system controls a display device to activate selected attracting elements that correspond with interface locations within a user interface that is being displayed. Consider that the display device can include an electronic display that is touch-based and thus accepts user inputs through the touch of the display. Further, consider that the display device may include a grid of attracting elements behind a display screen that can be individually activated. Thus, the display device functions to display an interface to a user for controlling various aspects of, for example, a vehicle, such as climate control, infotainment, and so on.

Additionally, a user may use an interface element to improve interaction with the display device. The interface element may be an implement that fits over a finger of the user and is infused with magnetically responsive material, such as iron. The interface element itself may also maintain capacitive characteristics similar to human skin such that contact with the touch-based display device functions similar to touch by the user without the interface element. Accordingly, the interface system can acquire a current state of an interface that is displayed on the display device and identify different interactive locations within the interface. The interactive locations may include buttons, sliders, and other features. Upon identifying the interactive locations, the system then, in one arrangement, correlates the interactive locations with the attracting elements. Correlating the interactive locations may include simply identifying which of the attracting elements correspond. In a further arrangement, the correlating may further include determining whether multiple attracting elements correspond to a single interactive location, whether an attracting element that corresponds exceeds boundaries of the interactive location, and so on. In these various circumstances, the system may correlate multiple attracting elements with a single interactive location, throttle (i.e., decrease) a force emitted by a corresponding element, and so on in order to maintain correspondence within an area of the interaction location.

In any case, once correlated, the interface system activates the corresponding attracting elements to attract the interface element to the interactive location. The interface system may further monitor for changes to the interface and update which of the attracting elements are active accordingly. Moreover, in order to improve interaction with the display device, the interface system also, in one arrangement, monitors a proximity of the interface element and a direction of movement of the interface element to the surface of the display. Thus, the interface system may adapt the attracting force according to the proximity and direction such that as the interface element is about to contact the surface, the attracting force can be reduced or wholly eliminated. In this way, the guidance provided by the interface system is subtle and helps guide the interface element without causing undesired attraction that may be difficult to relieve. In any case, the interface system improves interaction with a touch-based interface by improving the ability of a user to accurately provide inputs in environment that are unstable.

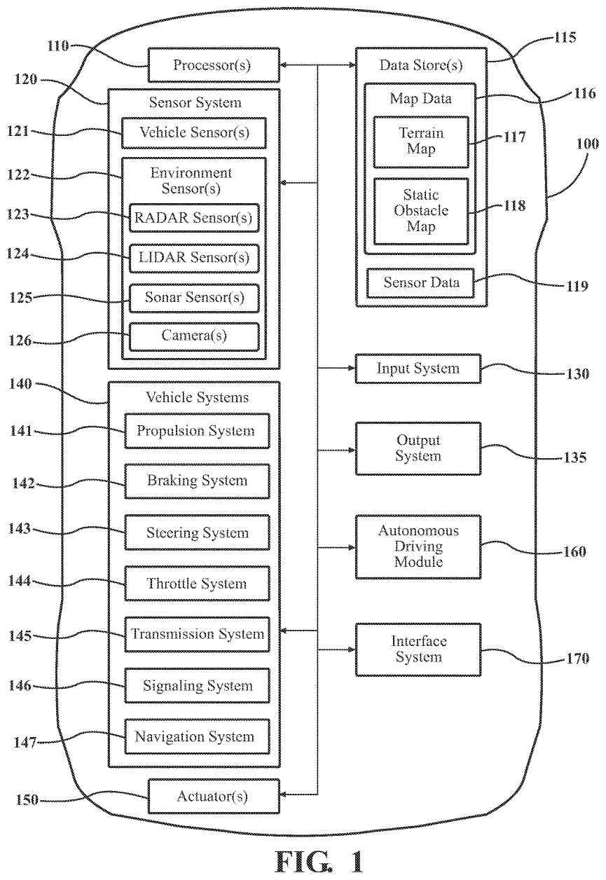

Referring to FIG. 1, an example of a vehicle 100 is illustrated. As used herein, a “vehicle” is any form of powered transport. In one or more implementations, the vehicle 100 is an automobile. While arrangements will be described herein with respect to automobiles, it will be understood that embodiments are not limited to automobiles. In some implementations, the vehicle 100 may be any electronic device that is associated with transportation and that, for example, may be used within a vehicle or other platform that benefits from improved accuracy on a touch-based interface.

In any case, the vehicle 100, as described herein, also includes various elements. It will be understood that, in various embodiments, it may not be necessary for the vehicle 100 to have all of the elements shown in FIG. 1. The vehicle 100 can have any combination of the various elements shown in FIG. 1. Further, the vehicle 100 can have additional elements to those shown in FIG. 1. In some arrangements, the vehicle 100 may be implemented without one or more of the elements shown in FIG. 1. While the various elements are illustrated as being located within the vehicle 100, it will be understood that one or more of these elements can be located external to the vehicle 100.

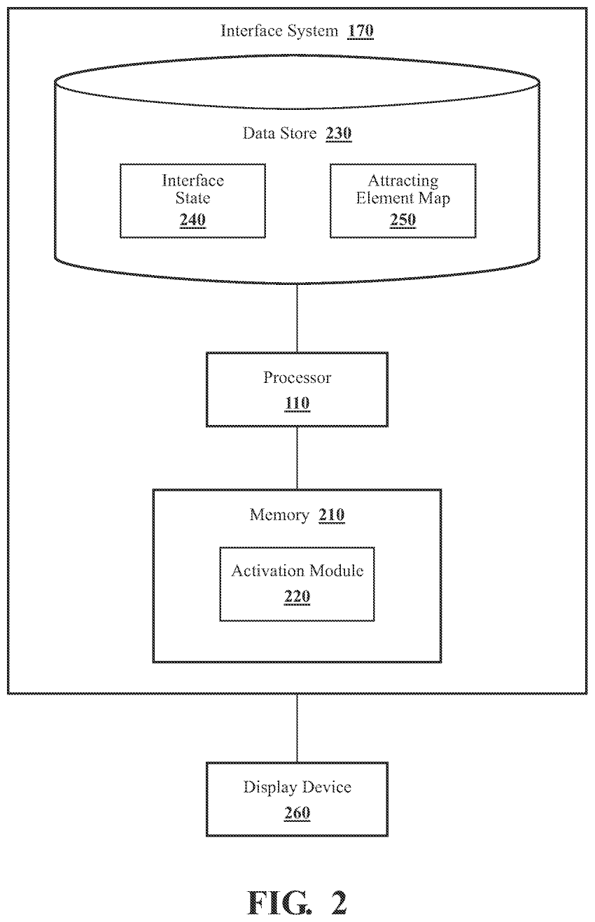

Some of the possible elements of the vehicle 100 are shown in FIG. 1 and will be described along with subsequent figures. However, a description of many of the elements in FIG. 1 will be provided after the discussion of FIGS. 2-8 for purposes of the brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements.

In any case, the vehicle 100 includes an interface system 170 that functions to improve the usability of a touch-based interface by controlling the activation of attracting elements in the interface. The noted functions and methods will become more apparent with a further discussion of the figures.

With reference to FIG. 2, one embodiment of the interface system 170 is further illustrated. The interface system 170 is shown as including a processor 110. Accordingly, the processor 110 may be a part of the interface system 170 or the interface system 170 may access the processor 110 through a data bus or another communication path. In one or more embodiments, the processor 110 is an application-specific integrated circuit (ASIC) that is configured to implement functions associated with an activation module 220. In general, the processor 110 is an electronic processor such as a microprocessor that is capable of performing various functions as described herein. In one embodiment, the interface system 170 includes a memory 210 that stores the activation module 220. The memory 210 is a random-access memory (RAM), read-only memory (ROM), a hard disk drive, a flash memory, or other suitable memory for storing the module 220. The module 220 is, for example, computer-readable instructions that, when executed by the processor 110, cause the processor 110 to perform the various functions disclosed herein. Of course, the module 220, in an alternative approach, includes hardware logic, a programmable logic array, or another hardware-based processing system that implements the instructions in a physical form.

Furthermore, in one embodiment, the interface system 170 includes a data store 230. The data store 230 is, in one arrangement, an electronic data structure such as a database that is stored in the memory 210 or another memory and that is configured with routines that can be executed by the processor 110 for analyzing stored data, providing stored data, organizing stored data, and so on. Thus, in one embodiment, the data store 230 stores data used by the module 220 in executing various functions. In one embodiment, the data store 230 includes an interface state 240 and an attracting element map 250, along with, for example, other information that is used by the module 220.

With continued reference to FIG. 2, the activation module 220 generally includes instructions that function to control the processor 110 to acquire the interface state 240 along with other information that may be used in controlling a display device 260. The display device 260 is, in at least one approach, a touch-based electronic device that displays a graphical user interface. In various arrangements, the display device 260 is integrated within a center console of the vehicle 100 and provides an interface for controlling infotainment components of the vehicle 100, HVAC components, cameras, doors, and other settings associated with the vehicle 100. Thus, the display device 260 may accept touch inputs from a user in order to provide for interaction with elements displayed thereon. The touch-based inputs may be detected using a capacitive layer, a force-based (e.g., pressure) array, or another technique known to facilitate touch inputs with an interface.

Whatever the particular form, the display device 260 provides for interacting with an interface by a user through physical touch of a screen of the display device 260.

Of course, in further arrangements, the functions discussed herein can be applied to other types of devices/interfaces beyond touch interfaces. For example, in one or more approaches, the interface system 170 can control attracting elements in physical buttons, knobs, and other interactive elements within a vehicle. By way of example, the physical buttons may be radio buttons/dials, climate control buttons, and other similar buttons that may be included within a vehicle.

In any case, continuing with the display device 260, the display device 260 further includes attracting elements. The attracting elements are, in one approach, electromagnetic coils that are disposed behind a screen of the display device 260 and generate electromagnetic fields that attract magnetically responsive materials (e.g., ferrous metals). The coils are, in one implementation, arranged in a grid including rows and columns that comprise a plurality of coils (e.g., 50). The precise number of coils may vary according to the implementation and generally correlates with an extent of granularity that is desired in providing the attracting forces. In one or more arrangements, a granularity of the grid may be associated with a size of interactive features and associated locations on the display device (e.g., a size of interface buttons).

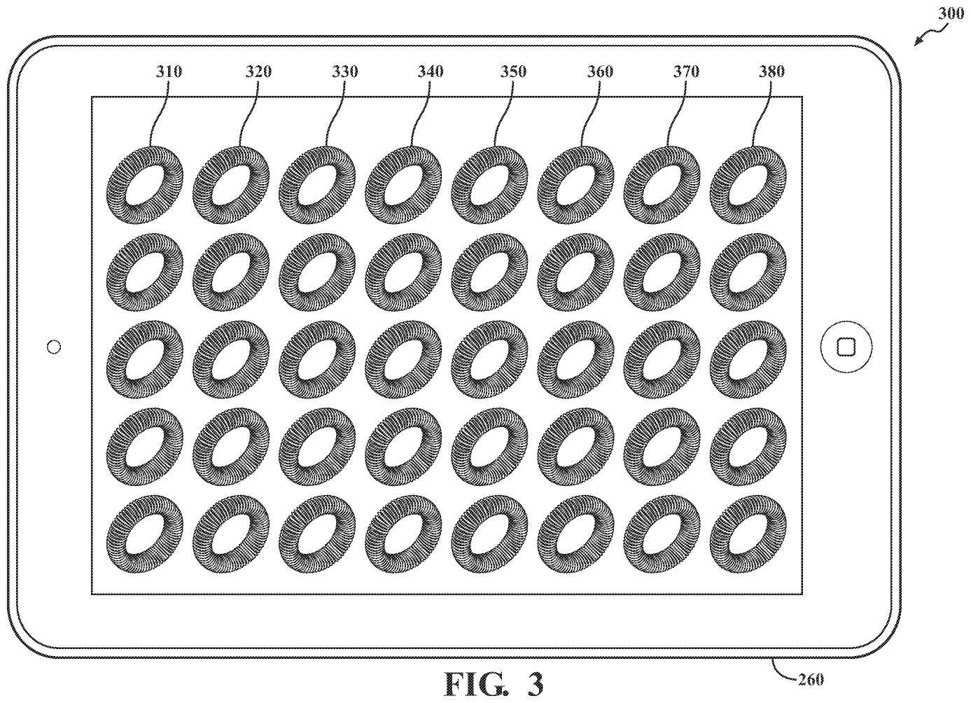

As one example of the grid of attracting elements, briefly consider FIG. 3. FIG. 3 illustrates one example of a grid 300 that may be embedded within the display device 260. As shown, the grid 300 includes a series of columns 310-380. The columns 310-380 include five separate rows of attracting elements. Thus, the grid 300 provides for covering a whole surface of the display device 260 in order to account for different possible locations of interactive elements within an interface. Moreover, the separate attracting elements are separately addressable so that activation module 220 can selectively activate individual elements in the grid 300.

Moreover, the activation module 220 can also regulate the attracting elements to provide variable levels of attraction. Thus, depending on a desired intensity of attraction, size of an interactive location (e.g., button), and so on, the activation module 220 can adjust the strength of an individual attracting element. In addition, the activation module 220 may also activate multiple attracting elements that are proximate to one another and may do so at different attracting strengths in order to provide a wide range of possibilities for implementing the attracting elements with an interface.

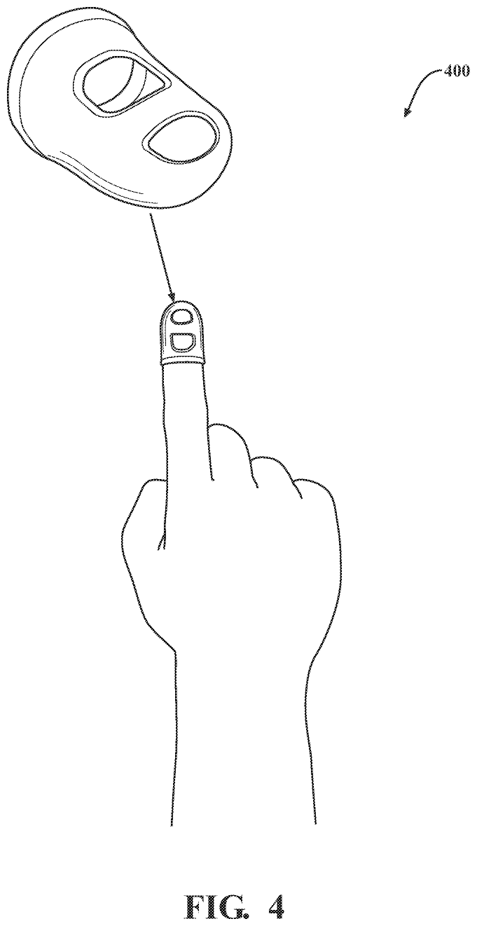

Furthermore, to provide an attracting force between the attracting elements and a user, the user generally wears a particular interface element. One example of an interface element is shown in FIG. 4. As shown, interface element 400 functions as a finger sleeve that fits over a finger (e.g., an index finger) of a user. In general, the interface element 400 can be formed from a silicone material or another material that functions with a capacitive touch interface. Moreover, the interface element includes embedded material that is magnetically responsive, such as iron, nickel, cobalt, etc. in a powder form. Accordingly, the interface element 400 functions to impart a sense of attractive force on the finger of the user when approaching an active attracting element. It should be appreciated that while the interface element 400 is shown as a finger sleeve, in further approaches, the interface element may be a glove that includes magnetically responsive material in a fingertip or another implement, such as a stylus.

In any case, the activation module 220 can selectively activate different ones of the attracting elements in the grid 300 to correspond with active locations in the interface. In one arrangement, the interface is a user interface that is generated by the processor 110 or another processor of the vehicle 100, and that includes rendered graphics depicting different controls and other interface elements. In one approach, the interface may display nearly any electronic content, such as web pages, video, visualizations, and so on. Whichever content is displayed, the interface generally includes interactive locations that control aspects of the interface itself (e.g., open windows), device settings, vehicle settings/controls, and so on.

Accordingly, in order to correlate the interactive locations within the display 260 and with the attracting elements of the grid 300, the activation module 220 determines a current state 240 of the interface. The current state 240 indicates characteristics of the interface, including locations of interactive features in the interface and parameters associated therewith, such as size of the feature, corresponding intensity of attraction that should be applied, size of attracting area, duration of attraction according to proximity of the user, and so on. Using this information, the activation module 220 identifies corresponding attracting elements and activates the corresponding elements in order to provide attracting forces that coerce the finger of the user toward interactive locations on the display device 260.

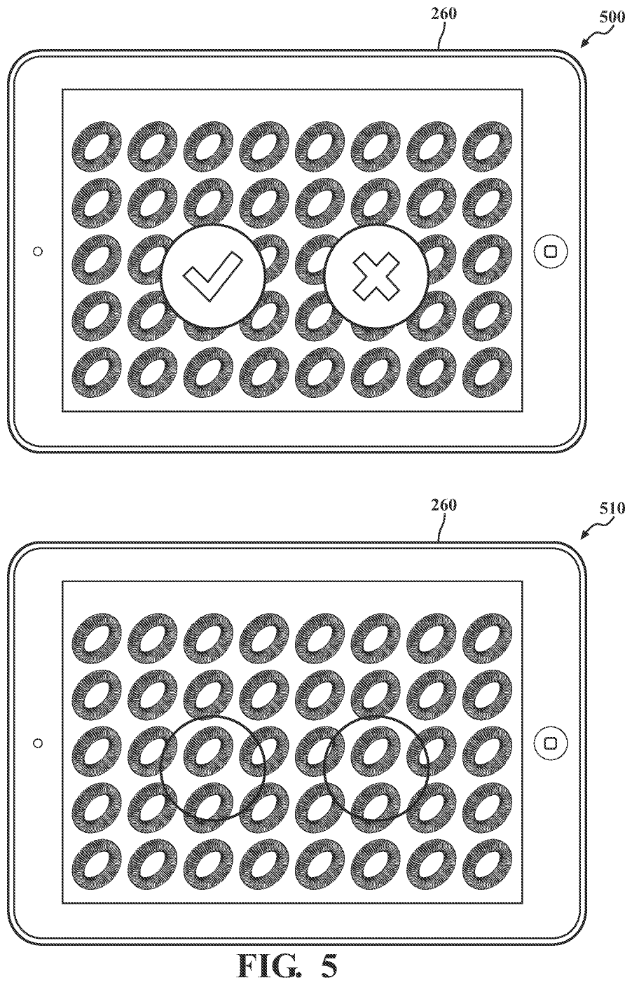

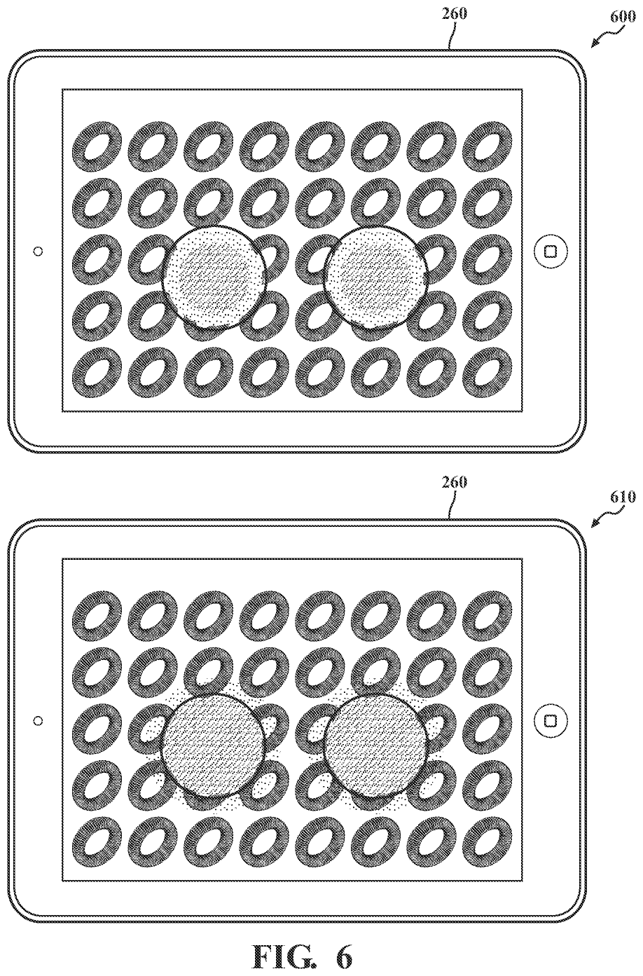

As a further explanation, consider FIGS. 5-6. FIG. 5 illustrates the display device 260 including the interface. A first illustration 500 shows two separate buttons within the interface that are displayed to a user. Thus, as shown, the buttons extend beyond an area of an individual attracting element. A second illustration 510 details an interactive location of the separate buttons from the illustration 500. Accordingly, from the illustration 510 it can be seen that the interactive locations associated with the buttons each correspond to nearly six separate coils. It should be appreciated that while the interactive locations cover more than one single attracting element, the activation module 220 may selectively activate the associated attracting elements and may do so at varying levels in order to provide accurate correspondence with the interactive location.

Further consider FIG. 6, which illustrates two separate examples 600 and 610 of attraction forces in relation to the interactive locations shown in FIG. 5. In example 600, the activation module 220 activates the attractive force from the grid of attracting elements to cover an area slightly smaller than the interactive locations. By comparison, in example 610, the activation module 220 activates the attracting elements to generate an attracting force that extends beyond boundaries of the interactive locations. In both cases, the activation module 220 can selectively activate different ones of the attracting elements and at varying levels of force to provide the attracting force at a desired extent in relation to the interactive location. In general, the form of the attracting force can be controlled according to parameters defined in relation to the interface itself. That is, programming of the interface can include programming parameters in order to inform the activation module 220 how to best generate the attraction force. In a further approach, the activation module 220 independently determines the form of the attracting force according to the shape of the interactive location and a particular context of the interface (e.g., emergency popup versus a default interface).

In further examples, the activation module 220 can shape the attracting force according to various characteristics. In one approach, the activation module 220 may cover only a top semi-circle of an interactive location, such as in example 600. For example, when a finger of the user may approach from a particular direction, such as the top, the activation module 220 may place the attracting force in an area that is defined according to a path of the approach. In any case, the activation module 220 can form the attracting force using the elements of the grid in many different ways to achieve improved accuracy by the user.

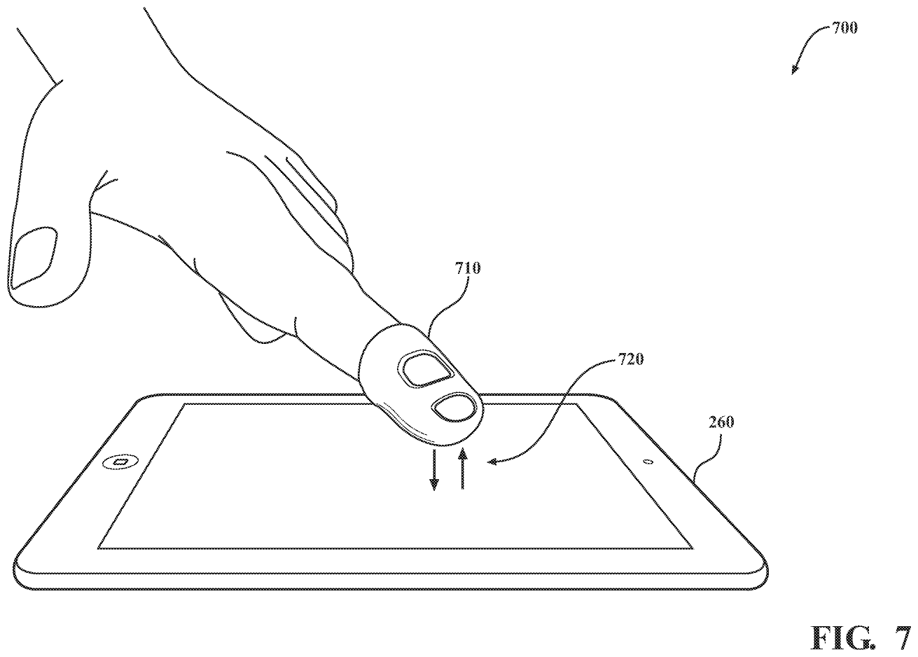

As a further aspect of how the activation module 220 can control the attracting elements of the display device, consider FIG. 7. FIG. 7 illustrates an example 700 of a finger of the user including an interface element 710 approaching a surface of the display device 260. The interface system 170, in one or more arrangements, further adapts the attracting force from the attracting elements according to a proximity 720 of the interface element to the display. That is, as the finger of the user with the interface element approaches the surface of the display device 260, the activation module 220 can selectively adapt a strength of the attracting force to further improve a feel of the attracting force.

For example, consider the following phases of interaction between the interface element worn by the user and the display device 260.

Phase 1: The interface element is approaching the surface from a starting position that is beyond a range of the attracting force.

Phase 2: The interface element is within the range of the attracting force proximate to the surface of the display device 260 (e.g., close to the surface, such as less than 5 mm) but not yet in contact with the surface.

Phase 3: The interface element is in physical contact with the surface of the display device 260.

Phase 4: Contact force between the interface element and the display device 260 is increasing. Phase 4 may also including swiping/sliding a “touch slider” interface element at a constant pressure.

Phase 5: The interface element is retracting from the surface but still in physical contact.

Phase 6: The interface element is retracting from the surface and is no longer in physical contact with the display device 260.

Accordingly, in one arrangement, the activation module 220 may leverage additional sensors of the display device 260 and/or the vehicle 100 in order to sense when the interface element reaches phase 2 or another phase, such as phase 3 or phase 5. In one approach, the interface system 170 receives sensor data about a position of the user, including at least a position of the interface element on a finger of the user, which may further include a direction of movement of the interface element. For example, the interface system 170 acquires, in one configuration, images/video from a 2D or 3D camera, a proximity sensor (e.g., infrared-based sensor), a force/pressure sensor, and so on. Whichever sensor type the interface system 170 leverages to monitor and determine a location of the interface element relative to the surface of the display device 260, the activation module 220 can adjust the attracting force to improve the interaction according to the location and the direction of movement for the interface element.

In one approach, the activation module 220 reduces or eliminates the attracting force at phase 2 when the interface element is about to contact the surface. This approach lessens the strength of the attraction yet still facilitates movement toward the interactive element. This may benefit the user by gently guiding the finger while still providing the user with the ability to easily retract the finger without touching the surface if the user does not intend to contact the surface. In yet a further approach, the activation module 220 reduces or eliminates the attraction force at phase 4 to permit the user to easily remove the interface element from the surface. Accordingly, the activation module 220 can dynamically adjust the attraction force provided by the attracting elements in order to further facilitate use of the display device 260. In a further aspect, the activation module 220 increases the attraction force at phase 5 in order to, for example, reset the display device 260 for subsequent use. As a further example, the activation module 220 can increase the force at phase 3 to facilitate maintaining contact. This may facilitate users with tremors that may skip around on the interface if the attraction force is lessened.

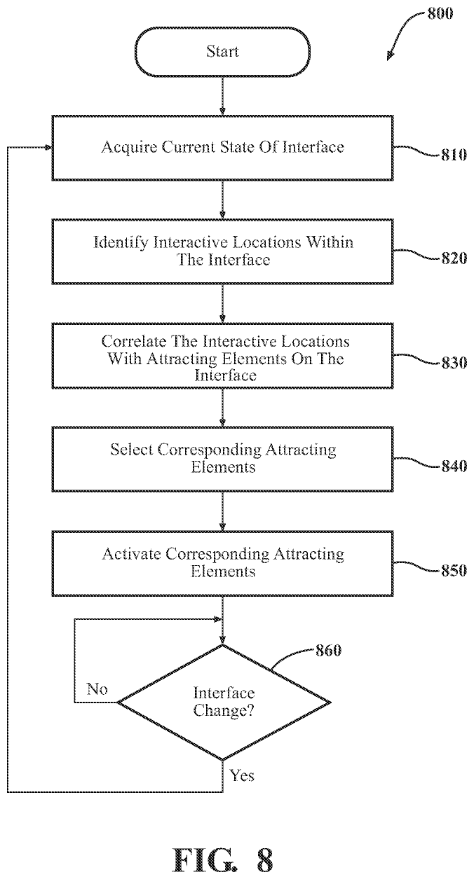

Additional aspects of improving the use of a touch-based interface by using magnetic attractive forces to snap an interface element toward interactive locations will be discussed in relation to FIG. 8. FIG. 8 illustrates a flowchart of a method 800 that is associated with controlling a grid of attracting elements with a display device to improve the accuracy of the user at interacting with an interface. Method 800 will be discussed from the perspective of the interface system 170. While method 800 is discussed in combination with the interface system 170, it should be appreciated that the method 800 is not limited to being implemented within the interface system 170 but is instead one example of a system that may implement the method 800.

At 810, the activation module 220 acquires the current interface state 240 from the interface. For example, as a system loads an interface or changes/updates an interface on the display device 260, the activation module 220 determines the interface state 240. In one approach, the activation module 220 receives the interface state 240 directly from the system providing the interface while in further approaches the activation module 220 may retrieve the interface state 240 through an application programming interface (API) or repository that includes the state 240. Furthermore, the activation module 220 may acquire the interface state 240 at regular intervals or according to an interrupt or another programming signal that identifies when the interface changes/updates elements displayed therein.

As an additional matter, the interface state 240 can include various information about the configuration of the interface, such as information about content, locations of interactive features, characteristics of the interactive features (e.g., size, shape, attractive forces to be used), and so on.

At 820, the activation module 220 identifies at least one interactive location within the interface according to the current interface state 240. In one arrangement, the activation module 220 identifies the interactive location by determining placement of interactive features within the interface. As previously noted, the interactive features are elements with which a user interacts to provide inputs to the display device 260. Thus, the interactive locations generally correspond to buttons, sliders, dials, free form input areas, and other input features of the interface. Furthermore, identifying the interaction locations generally includes determining placement within the interface in a format that corresponds to pixels of the display device 260 so that specific areas of the display device 260 can be identified. Thus, in one arrangement, the activation module 220 determines coordinates according to addressable pixel locations for edges of the interactive location. It should be appreciated that depending on a particular shape of the interactive location, the activation module 220 may use various approaches to identify the location, such as a center point and pixel width for circular elements, corner locations for rectangular features, and so on.

At 830, the activation module 220 correlates the interactive location with attracting elements within the display device 260. In one approach, the activation module 220 uses the attracting element map 250 to determine the correlation. For example, the map 250, in one configuration, identifies the correspondence between pixels of the display device 260 and locations within a grid for different attracting elements. Thus, the activation module 220 can compare the map 250 with the determined interaction locations to determine the correspondence.

At 840, the activation module 220 selects corresponding attracting elements. That is, according to the correspondence between the map 250 and the interactive location, the activation module 220 selects particular elements to activate. As a further aspect of the selection, the activation module 220 can determine additional attributes for the attraction force that is to be provided, such as a size, a placement, and a shape relative to the interactive location. Thus, activation module 220 does not necessarily select a single one of the attracting elements that, for example, falls within a center of the interactive location but instead may use multiple different attracting elements associated with an interactive location and may configure the attracting elements at different power levels to generate different attractive forces that together combine to provide an overall attracting force that has a size/shape/placement that is desired for a particular interactive location.

At 850, the activation module 220 activates at least one corresponding element of the attracting elements associated with the separate the interactive locations identified previously. Thus, the activation module 220 can activate the identified attracting elements to provide for attracting the interface element to interaction locations on the interface. In further aspects, the activation module 220 implements the activation according to additional considerations, such as sensing when the user is moving toward the interface to interact with the interface. For example, the activation module 220 may actively monitor the user while maintaining the attracting elements but in a ready state (i.e., programmed according to the previously identified correlations and characteristics). As such, when the activation module 220 identifies movement according to phase 1, as previously described, then the activation module 220 activates the attracting elements in order to facilitate interaction with the user.

Moreover, the activation module 220 may further function at 850 to selectively adjust the attraction force at further phases of interaction, as outlined previously. That is, for example, the activation module 220 may reduce (e.g., by 50% or more) the attraction force at phase 2 when the interface element is about to contact the surface of the display device. In even further aspects, the activation module 220 can adjust the attraction force at further phases, such as phase 4 by reducing the attraction force even further. In one arrangement, however, the activation module 220 may increase the attraction force at phases 3 and/or 4 when, for example, the interface element contacts a particular type of interface element, such as a slider or free form input area for writing a signature or providing other input that uses continued contact as opposed to ephemeral contact of a button. In this way, the interface system 170 can improve an ability of the user to interact with the display device 260 in an environment, such as within the vehicle 100.

At 860, the activation module 220 monitors for updates to the interface. In one approach, the activation module 220 determines when the interface state 240 changes and/or when the display device receives a new/updated interface for display. When this occurs, the activation module 220 proceeds with repeating functions associated with blocks 810-850 in order to ensure that the active attracting elements correspond to the interface. Accordingly, through the process described in relation to method 800 the interface system 170 is able to improve operation of a touch-based interface while a user is driving, improve accuracy for the user with interfacing a touch-based interface, reduce distraction and cognitive load for operating a touch-based interface, and improve operation by users with physical maladies.

FIG. 1 will now be discussed in full detail as an example environment within which the system and methods disclosed herein may operate. In some instances, the vehicle 100 is configured to switch selectively between an autonomous mode, one or more semi-autonomous operational modes, and/or a manual mode. Such switching can be implemented in a suitable manner, now known or later developed. “Manual mode” means that all of or a majority of the navigation and/or maneuvering of the vehicle is performed according to inputs received from a user (e.g., human driver). In one or more arrangements, the vehicle 100 can be a conventional vehicle that is configured to operate in only a manual mode.

In one or more embodiments, the vehicle 100 is an autonomous vehicle. As used herein, “autonomous vehicle” refers to a vehicle that operates in an autonomous mode. “Autonomous mode” refers to navigating and/or maneuvering the vehicle 100 along a travel route using one or more computing systems to control the vehicle 100 with minimal or no input from a human driver. In one or more embodiments, the vehicle 100 is highly automated or completely automated. In one embodiment, the vehicle 100 is configured with one or more semi-autonomous operational modes in which one or more computing systems perform a portion of the navigation and/or maneuvering of the vehicle along a travel route, and a vehicle operator (i.e., driver) provides inputs to the vehicle to perform a portion of the navigation and/or maneuvering of the vehicle 100 along a travel route.

The vehicle 100 can include one or more processors 110. In one or more arrangements, the processor(s) 110 can be a main processor of the vehicle 100. For instance, the processor(s) 110 can be an electronic control unit (ECU). The vehicle 100 can include one or more data stores 115 for storing one or more types of data. The data store 115 can include volatile and/or non-volatile memory. Examples of suitable data stores 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store 115 can be a component of the processor(s) 110, or the data store 115 can be operatively connected to the processor(s) 110 for use thereby. The term “operatively connected” or “communicably connected,” as used throughout this description, can include direct or indirect connections, including connections without direct physical contact.

In one or more arrangements, the one or more data stores 115 can include map data 116. The map data 116 can include maps of one or more geographic areas. In some instances, the map data 116 can include information or data on roads, traffic control devices, road markings, structures, features, and/or landmarks in the one or more geographic areas. The map data 116 can be in any suitable form. In some instances, the map data 116 can include aerial views of an area. In some instances, the map data 116 can include ground views of an area, including 360-degree ground views. The map data 116 can include measurements, dimensions, distances, and/or information for one or more items included in the map data 116 and/or relative to other items included in the map data 116. The map data 116 can include a digital map with information about road geometry. The map data 116 can be high quality and/or highly detailed.

In one or more arrangements, the map data 116 can include one or more terrain maps 117. The terrain map(s) 117 can include information about the ground, terrain, roads, surfaces, and/or other features of one or more geographic areas. The terrain map(s) 117 can include elevation data in the one or more geographic areas. The map data 116 can be high quality and/or highly detailed. The terrain map(s) 117 can define one or more ground surfaces, which can include paved roads, unpaved roads, land, and other things that define a ground surface.

In one or more arrangements, the map data 116 can include one or more static obstacle maps 118. The static obstacle map(s) 118 can include information about one or more static obstacles located within one or more geographic areas. A “static obstacle” is a physical object whose position does not change or substantially change over a period of time and/or whose size does not change or substantially change over a period of time. Examples of static obstacles include trees, buildings, curbs, fences, railings, medians, utility poles, statues, monuments, signs, benches, furniture, mailboxes, large rocks, hills. The static obstacles can be objects that extend above ground level. The one or more static obstacles included in the static obstacle map(s) 118 can have location data, size data, dimension data, material data, and/or other data associated with it. The static obstacle map(s) 118 can include measurements, dimensions, distances, and/or information for one or more static obstacles. The static obstacle map(s) 118 can be high quality and/or highly detailed. The static obstacle map(s) 118 can be updated to reflect changes within a mapped area.

The one or more data stores 115 can include sensor data 119. In this context, “sensor data” means any information about the sensors that the vehicle 100 is equipped with, including the capabilities and other information about such sensors. As will be explained below, the vehicle 100 can include the sensor system 120. The sensor data 119 can relate to one or more sensors of the sensor system 120. As an example, in one or more arrangements, the sensor data 119 can include information on one or more LIDAR sensors 124 of the sensor system 120.

In some instances, at least a portion of the map data 116 and/or the sensor data 119 can be located in one or more data stores 115 located onboard the vehicle 100. Alternatively, or in addition, at least a portion of the map data 116 and/or the sensor data 119 can be located in one or more data stores 115 that are located remotely from the vehicle 100.

As noted above, the vehicle 100 can include the sensor system 120. The sensor system 120 can include one or more sensors. “Sensor” means any device, component, and/or system that can detect, and/or sense something. The one or more sensors can be configured to detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors can work independently from each other. Alternatively, two or more of the sensors can work in combination with each other. In such a case, the two or more sensors can form a sensor network. The sensor system 120 and/or the one or more sensors can be operatively connected to the processor(s) 110, the data store(s) 115, and/or another element of the vehicle 100 (including any of the elements shown in FIG. 1). The sensor system 120 can acquire data of at least a portion of the external environment of the vehicle 100.

The sensor system 120 can include any suitable type of sensor. Various examples of different types of sensors will be described herein. However, it will be understood that the embodiments are not limited to the particular sensors described. The sensor system 120 can include one or more vehicle sensors 121. The vehicle sensor(s) 121 can detect, determine, and/or sense information about the vehicle 100 itself. In one or more arrangements, the vehicle sensor(s) 121 can be configured to detect, and/or sense position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system 147, and/or other suitable sensors. The vehicle sensor(s) 121 can be configured to detect, and/or sense one or more characteristics of the vehicle 100. In one or more arrangements, the vehicle sensor(s) 121 can include a speedometer to determine a current speed of the vehicle 100.

Alternatively, or in addition, the sensor system 120 can include one or more environment sensors 122 configured to acquire, and/or sense driving environment data. “Driving environment data” includes data or information about the external environment in which an autonomous vehicle is located or one or more portions thereof. For example, the one or more environment sensors 122 can be configured to detect, quantify and/or sense obstacles in at least a portion of the external environment of the vehicle 100 and/or information/data about such obstacles. Such obstacles may be stationary objects and/or dynamic objects. The one or more environment sensors 122 can be configured to detect, measure, quantify and/or sense other things in the external environment of the vehicle 100, such as, for example, lane markers, signs, traffic lights, traffic signs, lane lines, crosswalks, curbs proximate the vehicle 100, off-road objects, etc.

Various examples of sensors of the sensor system 120 will be described herein. The example sensors may be part of the one or more environment sensors 122 and/or the one or more vehicle sensors 121. However, it will be understood that the embodiments are not limited to the particular sensors described.

As an example, in one or more arrangements, the sensor system 120 can include one or more radar sensors 123, one or more LIDAR sensors 124 (e.g., 4 beam LiDAR), one or more sonar sensors 125, and/or one or more cameras 126. In one or more arrangements, the one or more cameras 126 can be high dynamic range (HDR) cameras or infrared (IR) cameras.

The vehicle 100 can include an input system 130. An “input system” includes any device, component, system, element or arrangement or groups thereof that enable information/data to be entered into a machine. The input system 130 can receive an input from a vehicle passenger (e.g., a driver or a passenger). The vehicle 100 can include an output system 135. An “output system” includes a device, or component, that enables information/data to be presented to a vehicle passenger (e.g., a person, a vehicle passenger, etc.).

The vehicle 100 can include one or more vehicle systems 140. Various examples of the one or more vehicle systems 140 are shown in FIG. 1. However, the vehicle 100 can include more, fewer, or different vehicle systems. It should be appreciated that although particular vehicle systems are separately defined, each or any of the systems or portions thereof may be otherwise combined or segregated via hardware and/or software within the vehicle 100. The vehicle 100 can include a propulsion system 141, a braking system 142, a steering system 143, throttle system 144, a transmission system 145, a signaling system 146, and/or a navigation system 147. Each of these systems can include one or more devices, components, and/or a combination thereof, now known or later developed. The braking system 142 may further embody an anti-lock braking system (ABS) that generally functions to prevent tires of the vehicle 100 from sliding during a braking maneuver. That is, the ABS functions to detect wheel slip and adjusts braking to prevent the wheel slip, thereby generally improving braking distances in various conditions. Moreover, the braking system 142 and/or the autonomous driving module 160 may include an electronic stability control (ESC) system that functions to selectively brake individual wheels of the vehicle 100 to maintain overall vehicle stability.

The navigation system 147 can include one or more devices, applications, and/or combinations thereof, now known or later developed, configured to determine the geographic location of the vehicle 100 and/or to determine a travel route for the vehicle 100. The navigation system 147 can include one or more mapping applications to determine a travel route for the vehicle 100. The navigation system 147 can include a global positioning system, a local positioning system, or a geolocation system.

The processor(s) 110, the interface system 170, and/or the autonomous driving module(s) 160 can be operatively connected to communicate with the various vehicle systems 140 and/or individual components thereof. For example, returning to FIG. 1, the processor(s) 110 and/or the autonomous driving module(s) 160 can be in communication to send and/or receive information from the various vehicle systems 140 to control the movement, speed, maneuvering, heading, direction, etc. of the vehicle 100. The processor(s) 110, the interface system 170, and/or the autonomous driving module(s) 160 may control some or all of these vehicle systems 140 and, thus, may be partially or fully autonomous.

The processor(s) 110, the interface system 170, and/or the autonomous driving module(s) 160 can be operatively connected to communicate with the various vehicle systems 140 and/or individual components thereof. For example, returning to FIG. 1, the processor(s) 110, the interface system 170, and/or the autonomous driving module(s) 160 can be in communication to send and/or receive information from the various vehicle systems 140 to control the movement, speed, maneuvering, heading, direction, etc. of the vehicle 100. The processor(s) 110, the interface system 170, and/or the autonomous driving module(s) 160 may control some or all of these vehicle systems 140.

The processor(s) 110, the interface system 170, and/or the autonomous driving module(s) 160 may be operable to control the navigation and/or maneuvering of the vehicle 100 by controlling one or more of the vehicle systems 140 and/or components thereof. For instance, when operating in an autonomous mode, the processor(s) 110, the interface system 170, and/or the autonomous driving module(s) 160 can control the direction and/or speed of the vehicle 100. The processor(s) 110, the interface system 170, and/or the autonomous driving module(s) 160 can cause the vehicle 100 to accelerate (e.g., by increasing the supply of fuel provided to the engine), decelerate (e.g., by decreasing the supply of fuel to the engine and/or by applying brakes) and/or change direction (e.g., by turning the front two wheels). As used herein, “cause” or “causing” means to make, force, compel, direct, command, instruct, and/or enable an event or action to occur or at least be in a state where such event or action may occur, either in a direct or indirect manner.

The vehicle 100 can include one or more actuators 150. The actuators 150 can be any element or combination of elements operable to modify, adjust and/or alter one or more of the vehicle systems 140 or components thereof to responsive to receiving signals or other inputs from the processor(s) 110 and/or the autonomous driving module(s) 160. Any suitable actuator can be used. For instance, the one or more actuators 150 can include motors, pneumatic actuators, hydraulic pistons, relays, solenoids, and/or piezoelectric actuators, just to name a few possibilities.

The vehicle 100 can include one or more modules, at least some of which are described herein. The modules can be implemented as computer-readable program code that, when executed by a processor 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processor(s) 110. Alternatively, or in addition, one or more data store 115 may contain such instructions.

In one or more arrangements, one or more of the modules described herein can include artificial or computational intelligence elements, e.g., neural network, fuzzy logic, or other machine learning algorithms. Further, in one or more arrangements, one or more of the modules can be distributed among a plurality of the modules described herein. In one or more arrangements, two or more of the modules described herein can be combined into a single module.

The vehicle 100 can include one or more autonomous driving modules 160. The autonomous driving module(s) 160 can be configured to receive data from the sensor system 120 and/or any other type of system capable of capturing information relating to the vehicle 100 and/or the external environment of the vehicle 100. In one or more arrangements, the autonomous driving module(s) 160 can use such data to generate one or more driving scene models. The autonomous driving module(s) 160 can determine a position and velocity of the vehicle 100. The autonomous driving module(s) 160 can determine the location of obstacles, obstacles, or other environmental features, including traffic signs, trees, shrubs, neighboring vehicles, pedestrians, etc.

The autonomous driving module(s) 160 can be configured to receive, and/or determine location information for obstacles within the external environment of the vehicle 100 for use by the processor(s) 110, and/or one or more of the modules described herein to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

The autonomous driving module(s) 160 either independently or in combination with the interface system 170 can be configured to determine travel path(s), current autonomous driving maneuvers for the vehicle 100, future autonomous driving maneuvers and/or modifications to current autonomous driving maneuvers based on data acquired by the sensor system 120, driving scene models, and/or data from any other suitable source. “Driving maneuver” means one or more actions that affect the movement of a vehicle. Examples of driving maneuvers include: accelerating, decelerating, braking, turning, moving in a lateral direction of the vehicle 100, changing travel lanes, merging into a travel lane, and/or reversing, just to name a few possibilities. The autonomous driving module(s) 160 can be configured to implement determined driving maneuvers. The autonomous driving module(s) 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The autonomous driving module(s) 160 can be configured to execute various vehicle functions and/or to transmit data to, receive data from, interact with, and/or control the vehicle 100 or one or more systems thereof (e.g., one or more of vehicle systems 140).

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-8, but the embodiments are not limited to the illustrated structure or application.

The flowcharts and block diagrams in the Figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, module, as used herein, includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™ Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

1. An interface system, comprising:
one or more processors; and
a memory communicably coupled to the one or more processors and storing:
an activation module including instructions that, when executed by the one or more processors, cause the one or more processors to:
identify an interactive location within an interface according to a current state of the interface;
correlate the interactive location with attracting elements within a device displaying the interface;
activate at least one corresponding element of the attracting elements to attract an interface element associated with a user to the interactive location
sense a proximity and a direction of movement of the interface element relative to the device; and
selectively adjust an attraction force of the at least one corresponding element by modifying the attraction force according to the proximity and the direction in which the interface element is moving in relation to the device, wherein modifying the attraction force includes i) reducing the attraction force when the interface element is moving toward and is proximate to the device and ii) increasing the attraction force when the interface element is moving away from the device.

2. The interface system of claim 1, wherein the activation module includes instructions to correlate the interactive location with the attracting elements including instructions to determine a location within a display of the interactive location relative to the attracting elements and selecting the at least one corresponding element according to the location.

3. The interface system of claim 1, wherein the attracting elements are arranged in a grid within the device, and
wherein the activation module includes instructions to identify the interactive location including instructions to determine placement of features within the interface with which the user interacts to provide inputs to the device.

4. The interface system of claim 1, wherein the activation module includes instructions to identify the interactive location including instructions to acquire the current state from the interface when the interface updates to adapt which of the attracting elements are active.

5. The interface system of claim 1, wherein the activation module includes instructions to activate the at least one corresponding element including instructions to cause the at least one corresponding element to generate an electromagnetic field to attract the interface element, and
wherein the attracting elements are electromagnets and the interface element is formed of a magnetically responsive material.

6. The interface system of claim 1,
wherein sensing the direction of movement includes using one or more sensors of the device to detect the interface element and determine the direction of the movement.

7. (canceled)

8. The interface system of claim 6, wherein the activation module includes instructions to sense the proximity including instructions to determine a direction of movement toward or away from the device.

9. A non-transitory computer-readable medium comprising instructions that, when executed by one or more processors, cause the one or more processors to:
identify an interactive location within an interface according to a current state of the interface;
correlate the interactive location with attracting elements within a device displaying the interface;
activate at least one corresponding element of the attracting elements to attract an interface element associated with a user to the interactive location
sense a proximity and a direction of movement of the interface element relative to the device; and
selectively adjust an attraction force of the at least one corresponding element by modifying the attraction force according to the proximity and the direction in which the interface element is moving in relation to the device, wherein modifying the attraction force includes i) reducing the attraction force when the interface element is moving toward and is proximate to the device and ii) increasing the attraction force when the interface element is moving away from the device.

10. The non-transitory computer-readable medium of claim 9, wherein the instructions to correlate the interactive location with the attracting elements include instructions to determine a location within a display of the interactive location relative to the attracting elements and selecting the at least one corresponding element according to the location.

11. The non-transitory computer-readable medium of claim 9, wherein the attracting elements are arranged in a grid within the device, and
wherein the instructions to identify the interactive location include instructions to determine placement of features within the interface with which the user interacts to provide inputs to the device.

12. The non-transitory computer-readable medium of claim 9, wherein the instructions to identify the interactive location include instructions to acquire the current state from the interface when the interface updates to adapt which of the attracting elements are active.

13. The non-transitory computer-readable medium of claim 9, wherein the instructions to activate the at least one corresponding element include instructions to cause the at least one corresponding element to generate an electromagnetic field to attract the interface element.

14. A method, comprising:
identifying an interactive location within an interface according to a current state of the interface;
correlating the interactive location with attracting elements within a device displaying the interface;
activating at least one corresponding element of the attracting elements to attract an interface element associated with a user to the interactive location;
sensing a proximity and a direction of movement of the interface element relative to the device; and
selectively adjusting an attraction force of the at least one corresponding element by modifying the attraction force according to the proximity and the direction in which the interface element is moving in relation to the device, wherein modifying the attraction force includes i) reducing the attraction force when the interface element is moving toward and is proximate to the device and ii) increasing the attraction force when the interface element is moving away from the device.

15. The method of claim 14, wherein correlating the interactive location with the attracting elements includes determining a location within a display of the interactive location relative to the attracting elements and selecting the at least one corresponding element according to the location.

16. The method of claim 14, wherein the attracting elements are arranged in a grid within the device, and
wherein identifying the interactive location includes determining placement of features within the interface with which the user interacts to provide inputs to the device.

17. The method of claim 14, wherein identifying the interactive location includes acquiring the current state from the interface when the interface updates to adapt which of the attracting elements are active.

18. The method of claim 14, wherein activating the at least one corresponding element includes causing the at least one corresponding element to generate an electromagnetic field to attract the interface element, and
wherein the attracting elements are electromagnets and the interface element is formed of a magnetically responsive material.

19. The method of claim 14,
wherein sensing the direction of movement includes using one or more sensors of the device to detect the interface element and determine the direction of the movement.

20. (canceled)
